(19) United States
(12) Patent Application Publication
(10) Pub. No.: US 2023/0161331 A1
(43) Pub. Date: May 25, 2023

(54) METHOD FOR PROGRAMMING A PLANT CONTROL SYSTEM

(71) Applicant: Goran Music, Wien (AT)

(72) Inventor: Goran Music, Wien (AT)

(21) Appl. No.: 17/921,095

(22) PCT Filed: Apr. 26, 2021
(86) PCT No.: PCT/AT2021/060142

§ 371 Date: Oct. 24, 2022

(30) Foreign Application Priority Data
Apr. 25, 2020 (AT) A60120/2020

(51) Int. Cl. G05B 19/418

(52) U.S. Cl. CPC G05B 19/41835; G05B 2219/31368

(57) ABSTRACT

In a method for programming a plant control system having a plurality of control units (6) connected to one another and to sensors and/or actuators, a plurality of component templates (2) of plant parts are called up from a component template memory (1), and components (4) are created from these templates and are linked to one another in a plant description (3). For each component (4) of the plant description (3), a component program code is transmitted to an allocated control unit (6). The method makes it possible to start up a plant control system easily and time-efficiently with minimal testing and maintenance effort, even in the case of complex plants.

### FIELD OF THE INVENTION

The invention relates to a method for programming a plant control system having a plurality of control units connected to one another and to sensors and/or actuators, wherein a plurality of component templates of plant parts are retrieved from a component template memory, and components are created therefrom and are linked to one another in a plant description, wherein, for each component of the plant description, a component program code is transmitted to an assigned control unit.

### DESCRIPTION OF THE PRIOR ART

In the context of industrial automation solutions, methods of the type described above are known, for example, from EP 2533148 A1. Components can be plant parts, such as actuators, which are controlled via control units of the plant control system on the basis of the measured values of sensors. For this purpose, a large number of different control and sensor data must be exchanged between the control units and the sensors or actuators on the one hand and between the control units themselves on the other, with several such data connections usually being required between the individual plant components. For example, in the case of a production machine as a plant, this can have several components in the form of controllable axes, each comprising at least one drive. In this case, in order to specify a reproducible production sequence as program code, which is defined, for example, by a sequence of different driven axes at in each case specific speeds as component descriptions, the individual data links of the components must first be linked to one another, whereupon component program code is generated by a code generator and transmitted to the plant control system. However, a disadvantage of the previously known methods is that, particularly in the case of complex systems, due to the large number of components and the associated large number of linking options, a quantity of links and signal flows that is sometimes difficult for the user to keep track of must be mapped in order to be able to generate program code therefrom. As a result, the programming of a plant control system becomes complex and error-prone because the individual data connections between the components have to be created manually from scratch, which impairs the testability and maintainability of the entire plant control system.

### SUMMARY OF THE INVENTION

There is thus a need to design a method of the type described at the beginning in such a way that simple and time-efficient programming of a plant control system is made possible with a testing and maintenance effort as low as possible, even for complex plants.

The invention solves the set object in that the component templates have function descriptions and interface descriptions with one or more connection descriptions for data exchange, the created components comprise interfaces corresponding to the interface descriptions, and matching interfaces of different components are connected via component connections, wherein a control unit of the plant control system is selected for each component of the plant description, whereupon a component program code adapted to the control unit and the sensors and/or actuators connected to it is generated by a code generator from the function description of the component template of the component and from the connected interfaces and is transmitted to the selected control unit.

The invention is based on the consideration that, for reduced programming time and low testing and maintenance effort, not only are the functions of the control units and the components implemented thereon abstracted into reusable function descriptions and stored in the component template memory, but that these functions also require interaction with the connections of the control units. In order to facilitate the assignment of these connections, which usually transmit only primitive data types, to each other and to the part of the component program code mapping the functions, the individual connections are abstracted in the sense of the invention into connection descriptions and combined into interface descriptions mapping complex functionalities, which interface descriptions are stored together with the function descriptions for each component template in the component template memory. For programming a plant control system, these component templates are then retrieved from the component template memory, and one or more components with interfaces are created from each component template, which are linked together in a plant description via component connections. In the process, each component is assigned a physical control unit, wherein a control unit can in principle also comprise several components. Each component connection thus preferably represents the complete communication between two components, which can run over several physical connections of the selected control unit. Based on such a system description, a component program code is then created for each component with the aid of a code generator for the control unit assigned to the component, which component code maps both the function description and the interfaces defined in the system description and associated with component connections in a program code that can be executed by the control unit. Such a program code can, for example, comply with EN standard 61131. Since such program code at the control unit level does not of itself support an abstraction of the connections to interfaces corresponding to the invention, it is proposed that the code generator create code artifacts for the interfaces as well as code artifacts for the connections of the interfaces as part of the generation of the component program code, wherein the code artifacts for the interfaces allow a common addressing of several connections. As a result of this action, the code artifacts corresponding to the function description can also access the code artifacts for the interfaces, so that the function descriptions have a lower, and thus more easily maintained, level of complexity. For example, the analog preset value for an actuating cylinder and the analog measured value of an incremental encoder that records the actuating travel of the actuating cylinder can be combined as two connections to form a common interface that provides the functionality of the actuating cylinder for a component or for its function description.

Although the function descriptions are also kept abstract in principle and can only be translated into program code by the code generator, particularly reliable programming results if the function descriptions of the component templates have function program code which is translated by the code generator into component program code for the components generated from the component template on the basis of the connected interfaces before transmission to the selected control unit. This means that the function program code can already be executed directly by the selected control unit, although correspondingly different function program code can also be stored with the function description for different control units. As already explained above, this function program code is translated before transmission to the control unit only to the extent that the code artifacts for the interfaces called up in the function program code are generated together with the code artifacts for the connections by the code generator and output together with the function program code as component program code. In this way, the function program code can already be tested on the target platform without having to regenerate it each time.

In order to reduce the complexity of a plant description and thus the time required for programming, it is proposed in accordance with the invention that the component templates comprise parameter descriptions and the components comprise predefined parameters corresponding to the parameter descriptions, which are transferred to the selected control units together with the component program code. This allows individual component templates to be used for a larger number of different plant components, with only a few parameters needing to be adjusted as part of the process of creating the plant description. Such parameters can be, for example, the maximum travel of a cylinder, the motor type used, or the information whether a hydraulic cylinder or a linear drive is controlled. The parameters can either be embedded directly in the component program code or transmitted to the selected control unit as a separate data record.

However, the parameters can also be used for the code generator to adapt the component program code on the basis of the specified parameters before transmission to the selected control unit. For example, depending on the controlled drive, parts of the function program code can be deactivated or activated.

Although different data formats can be selected for the plant description, a particularly efficient data storage results for the illustration of the components and the component connections if the plant description forms a graph, whose nodes are components that are linked to each other via an intermediate edge in each case. The edge represents a component connection, wherein the provision of only one component connection between two components makes a particularly simple synchronization possible of the data exchange within a component. If several component connections were permissible between two components, the data exchange between the two component connections would have to be synchronized to enable reliable control by the control units.

### BRIEF DESCRIPTION OF THE INVENTION

In the drawing, the subject matter of the invention is shown by way of example, wherein:

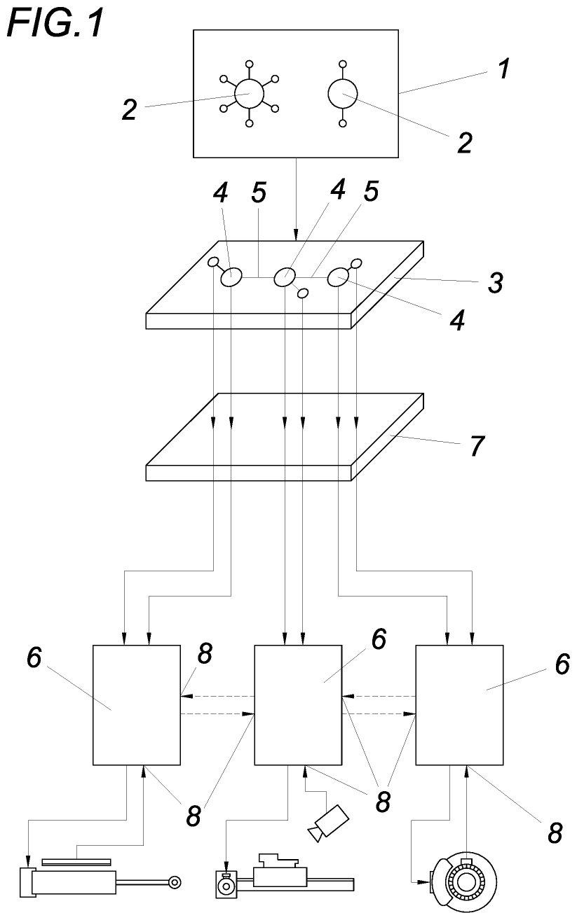

FIG. 1 shows a schematic overview of the component template memory, the plant description, the code generator, the individual control units and the actuators and sensors connected to them, and

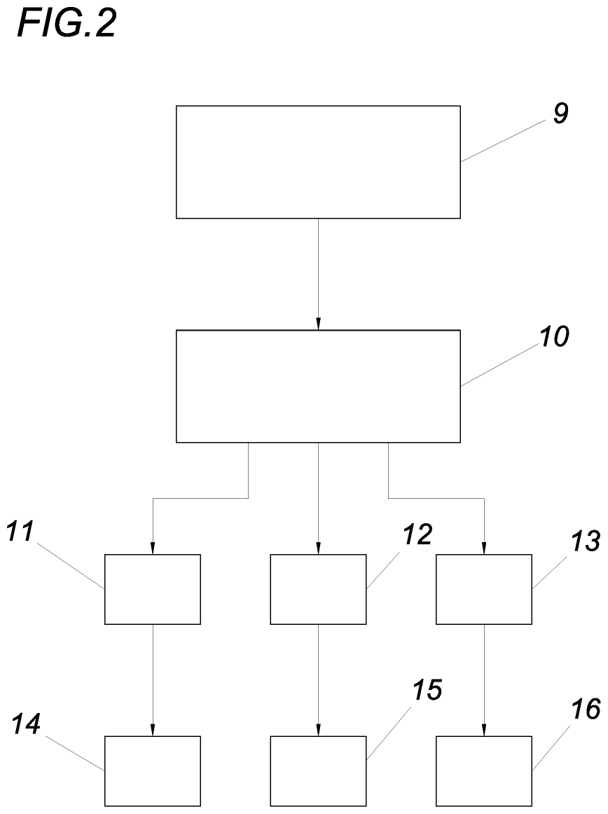

FIG. 2 shows a schematic flow diagram of the method according to the invention.

### DETAILED DESCRIPTION OF THE PREFERRED EMBODIMENTS

For the method according to the invention, a component template memory 1 is provided in which individual component templates 2 are stored. These component templates 2 comprise both a function description and an interface description, as shown symbolically in FIG. 1. From these component templates 2, components 4 are generated in a plant description 3, which are interconnected within the plant description 3 via component connections 5. The plant description 3 is preferably represented as a graph whose nodes form the components 4 and whose edges form the component connections 5.

As explained in detail above, each component 4 is assigned a control unit 6, although several components 4 can also each be assigned to a control unit 6. A code generator 7 is used to generate component program code from each component, which is subsequently transmitted to the assigned control unit 6. In FIG. 1, some connections 8 are designated by way of example.

This component program code includes code artifacts generated from the function description of the component template 2 of the respective component 4 and code artifacts generated from the interfaces of the respective component 4 connected via component connections 5. In addition, the component program code also includes code artifacts that connect the individual connections 8 of the control units 6 to the code artifacts of the interfaces in the sense of glue logic.

A method according to the invention for programming a plant control system comprises several steps shown in FIG. 2 in a preferred embodiment. First, component templates are retrieved from the component template memory (9) and one or more components with interfaces are created from each component template, which are linked to one another in a plant description via component connections (10). In the process, each component is assigned a physical control unit, wherein a control unit can in principle also comprise several components. Each component connection thus preferably maps the complete communication between two components, which can run via several physical connections of the selected control unit. Based on such a plant description, a component program code for the control unit assigned to the component is then created for each component with the aid of a code generator (11, 12, 13), which maps both the function description and the interfaces defined in the plant description and associated with component connections in a program code that can be executed by the control unit. For example, the analog preset value for an actuating cylinder and the analog measured value of an incremental encoder that records the actuating travel of the actuating cylinder can be combined as two connections to form a common interface that provides the functionality of the actuating cylinder for a component or for its function description. Then the respective program code is transferred to the individual control units (14, 15, 16).

1. A method for programming a plant control system having a plurality of control units connected to one another and to sensors and/or actuators, said method comprising:
retrieving a plurality of component templates of plant parts from a component template memory; and
creating components said component templates and linking said components to one another in a plant description; and
transmitting, for each component of the plant description, a component program code to an assigned control unit;
wherein the component templates have function descriptions and interface descriptions with one or more connection descriptions for data exchange, the created components comprise interfaces corresponding to the interface descriptions, and matching interfaces of different components are connected via component connections; and
selecting a control unit of the plant control system for each component of the plant description, and then generating by a code generator a component program code adapted to the control unit and the sensors and/or actuators connected thereto from the function description of the component template of the component and from the connected interfaces; and
transmitting the component program code to the selected control unit.

2. The method according to claim 1, wherein the function descriptions of the component templates comprise function program code that is translated by the code generator into the component program code for the components generated from the component template on the basis of the connected interfaces before transmission to the selected control unit.

3. The method according to claim 1, wherein the component templates comprise parameter descriptions and the components comprise predetermined parameters corresponding to the parameter descriptions, and said parameters are transmitted together with the component program code to the selected control units.

4. The method according to claim 3, wherein the code generator adapts the component program code on the basis of the predetermined parameters before said component program code is transmitted to the selected control unit.

5. The method according to claim 1 wherein the plant description forms a graph having nodes that are components linked to each other via an intermediate edge in each case.

6. The method according to claim 2, wherein the component templates comprise parameter descriptions and the components comprise predetermined parameters corresponding to the parameter descriptions, and said parameters are transmitted together with the component program code to the selected control units.

7. The method according to claim 6, wherein the code generator adapts the component program code on the basis of the predetermined parameters before said component program code is transmitted to the selected control unit.

8. The method according to claim 2, wherein the plant description forms a graph having nodes that are components linked to each other via an intermediate edge in each case.

9. The method according to claim 3, wherein the plant description forms a graph having nodes that are components linked to each other via an intermediate edge in each case.

10. The method according to claim 4, wherein the plant description forms a graph having nodes that are components linked to each other via an intermediate edge in each case.

11. The method according to claim 6, wherein the plant description forms a graph having nodes that are components linked to each other via an intermediate edge in each case.

12. The method according to claim 7, wherein the plant description forms a graph having nodes that are components linked to each other via an intermediate edge in each case.
